(19) United States
(12) Patent Application Publication
(10) Pub. No.: US 2004/0128658 A1
(43) Pub. Date: Jul. 1, 2004

(54) Exception handling with stack trace cache

(76) Inventors: Guei-Yuan Lueh, San Jose, CA (US); Gansha Wu, Beijing (CN)

Correspondence Address: Timothy N. Trop, TROP, PRUNER & HU, P.C., STE. 100, 8554 KATY FWY, HOUSTON, TX, 77024-1841, US

(21) Appl. No.: 10/330,374

(22) Filed: Dec. 27, 2002

(51) Int. Cl. G06F 9/45

(52) U.S. Cl. 717/151; 717/162; 717/148

(57) ABSTRACT

During stack unwinding, stack trace information relating to one or more stack frames may be stored in cache memory. Subsequent exceptions can access and copy the cached stack trace information instead of rewinding additional frames in the runtime call stack. An indicator may specify if the stack trace information was cached for a first or earlier exception. The cached stack trace information may include the source location of an exception handler.

### BACKGROUND

This invention relates generally to handling exceptions in software applications for processor-based systems, and specifically to stack unwinding during the exception throwing process.

Modern software languages such as Java, C#, and C++ use exception handling to provide error-handling capacities for their programs. An exception is an abnormal event that disrupts the normal execution of the software. Exception handling allows the code to be written to explicitly identify the exceptions that may be handled.

For example, an exception handler may be invoked through a “try” block in C# and C++. Code that is to be subjected to exception handling is placed inside the try block. A “throw” expression interrupts the current execution flow, passes control to an appropriate exception handler and specifies the origin or type of the exception. A try block is followed by one or more “catch” clauses, which handle different types of exceptions. Thus, exception handlers are coded in the catch blocks which can try to fix the problem or log the error and exit.

Some software programs use exception handling as a convenient way to direct and/or transfer execution control across function boundaries. For example, exceptions may be used to pass information about anomalous runtime conditions and to transfer control to an appropriate handler. In general, software programs with exception handling are typically more robust and easier to understand than programs that handle errors by returning error values.

When an exception occurs, the normal flow of execution is interrupted and the exception handling mechanism starts searching for a matching handler. If a handler cannot be found, it pops the current function from the stack and the search resumes in the calling function. This process, which is referred to as stack unwinding, continues until a matching handler is found or the program terminates.

A stack unwinding mechanism involved in the exception throwing process in a runtime system unwinds or walks up the stack frames from the bottom frame of the runtime call stack, one frame at a time, and uses the records deposited by the compiler to discover the topmost handler that handles the exception. To perform unwinding and enumerate the root set to correct the exception (i.e., by “collecting garbage” or defragmenting and running the called function again), a compiler may record information for each method such as the size of the method frame and live references on the frame with a given instruction pointer within the method.

If an exception occurs, an exception object may be constructed and filled in with the stack trace information. Stack trace information includes a list of stack frames, context information associated with each frame, current instruction pointer (ip) or source line number information.

Thus, stack unwinding involves tracing backwards through the activation records contained in the call stack. Stack unwinding may trace back through a series of stack frames, from the stack frame for the most recently called procedure to that for the outermost procedure. The runtime system generates a stack trace for the exception to be thrown. While the stack is unwound, values of preserved registers may be recovered so that the exception handler may access the correct values for variables.

Stack unwinding incurs significant runtime overhead. The deeper the call chain is from which an exception is thrown, the higher the runtime overhead that may be used. Some software programs frequently throw exceptions from deep call chains of 30 or more frames. For those applications, the time and inefficiency of exception handling can be a serious problem that adversely impacts performance of the processor-based system.

There is a need for improved handling of exceptions in software programs that will reduce runtime overhead and help improve processor performance. There is a need for minimizing runtime overhead for stack unwinding. There is a need for handling exceptions without unwinding all of the frames in a stack.

### BRIEF DESCRIPTION OF THE DRAWINGS

FIG. 1 is a block diagram of an exception handling method according to one embodiment of the invention.

FIG. 2 is a block diagram of an exception handling method according to one embodiment of the invention.

FIG. 3A is a schematic diagram of a stack trace cache after one full unwinding according to one embodiment.

FIG. 3B is a schematic diagram of three stack traces during execution of a program, after stack unwinding for a first exception, and reaching a previously cached frame for a second exception, according to one embodiment.

FIG. 4 is a block diagram of a processor based system according to one embodiment of the invention.

### DETAILED DESCRIPTION

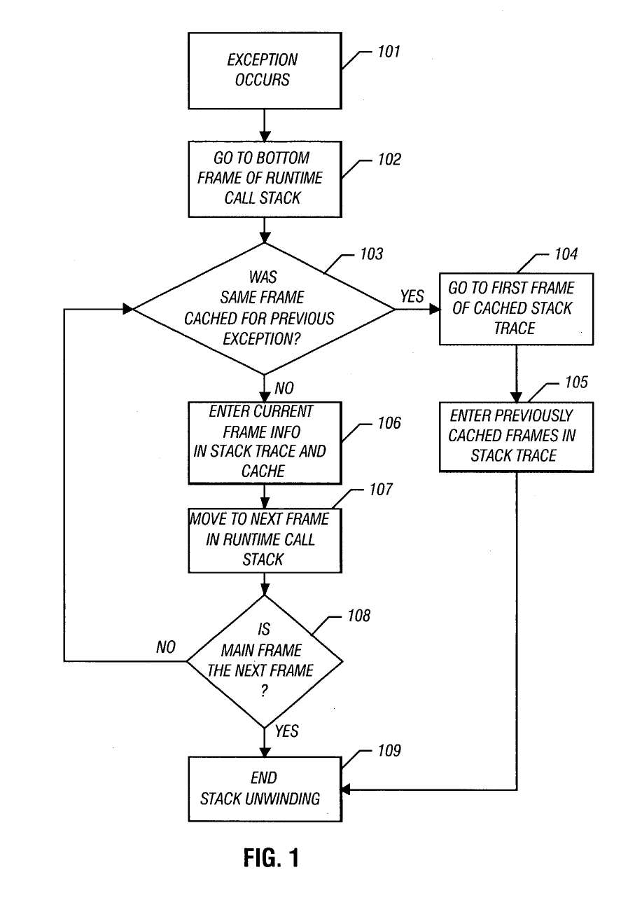

According to one embodiment of the invention, as shown in FIG. 1, in block 101, an exception may occur during runtime of a software program on a processor-based system. It is well known that a large number of different events or conditions may cause an exception to result in a software program. In block 102, the compiler goes to the bottom frame of the runtime call stack. The bottom frame is the most recently called procedure of a software program.

In block 103, it is determined if stack trace information for the bottom stack frame was stored in cache memory for a first or previous exception. If the stack trace information was cached for that stack frame, full stack unwinding may be avoided when filling the stack trace for the current exception.

In general, there may be one or more stack frames that remain unchanged between two consecutive exception throws. If a stack frame is unchanged after the first or previous exception, runtime overhead may be reduced by copying the stack trace information from cache memory for the next exception that includes the same stack frame, instead of unwinding all of the remaining frames in the runtime call stack.

In one embodiment, the compiler may tag a stack frame from a first or earlier exception to show that the stack trace information for the stack frame was cached. In one embodiment, an indicator or tag may be provided on each stack frame. More specifically, in one embodiment, a slot may be allocated which may be referred to as “in_cache.” In this example, the slot may have two alternative values, “true” or “false.” For example, in the prolog, before any exception is reached during runtime, a compiler may generate a store instruction writing “false” to in_cache. Thus, each stack frame's in_cache slot may be initialized with a default value “false,” indicating that no stack trace information for that stack frame is in cache memory. As will be discussed below, the slot will be changed to “true” flowing an exception that invokes that stack frame.

In one embodiment, each stack frame in cache memory may be represented by an instruction pointer (ip) and a stack pointer (sp). The ip is sufficient to print out the frame information for the stack trace, i.e., the source location of the exception handler and the method name. The sp identifies if the stack frame was popped since the last exception throwing.

In block 103, during stack unwinding, a stack frame may be reached in which stack trace information was stored in cache memory for a first or previous exception. For example, in one embodiment, a stack frame may have an “in_cache” slot that is “true.” If the stack frame has not changed since the last exception occurred, i.e., the ip has not been updated, the stack trace information may be copied and reused for the current exception.

In block 104, if the stack trace information for the stack frame was cached for a first or previous exception, the compiler determines the first shared stack frame that was cached. The start of the stack trace information for shared stack frames may be detected instead of unwinding the rest of the frames in the current stack. For the shared stack trace, the stack pointer (sp) of the frame in the cached stack trace is the same as each frame of the current exception.

In block 105, in one embodiment, the previously cached stack trace information in frames having the same stack pointer as the frames in the current exception may be copied and/or entered in the stack trace for the current exception.

In block 106, if the same frame was not previously cached for a first or earlier exception, the current stack trace information may be entered into the stack trace and cached. In one embodiment, the stack trace cache may be updated with the stack trace information, including the ip and sp, for each frame that is currently on the stack, and “true” may be written to the “in_cache” slot of the stack frames.

In block 107, the compiler moves from the current frame up to the next frame in the runtime call stack. In block 108, it is determined if the next frame is the main frame in the call stack. If the next frame is not the main frame, return to block 103. If the next frame is the main frame, stack unwinding may terminate in block 109.

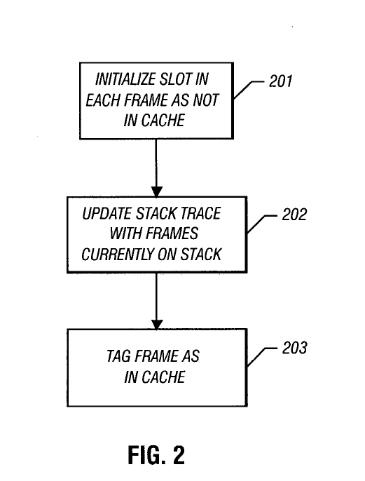

FIG. 2 is a block diagram showing the identification of whether or not stack trace information for a frame is stored in cache according to one embodiment. In block 201, a slot in each frame may be initialized as “not in cache.” In one embodiment, the “in_cache” slot may be initialized as “false.”

In block 202, according to one embodiment, the stack trace is updated with each stack trace frame currently on the runtime call stack for an exception. The stack trace may be updated by unwinding, one frame at a time, from the bottom of the runtime call stack.

In block 203, each frame that is unwound from the call stack may be tagged to indicate that the stack trace information is now stored in cache. In one embodiment of the invention, the value of the “in_cache” slot may be changed to “true.” As a result, stack trace information stored in cache memory may be copied and used for the next exception.

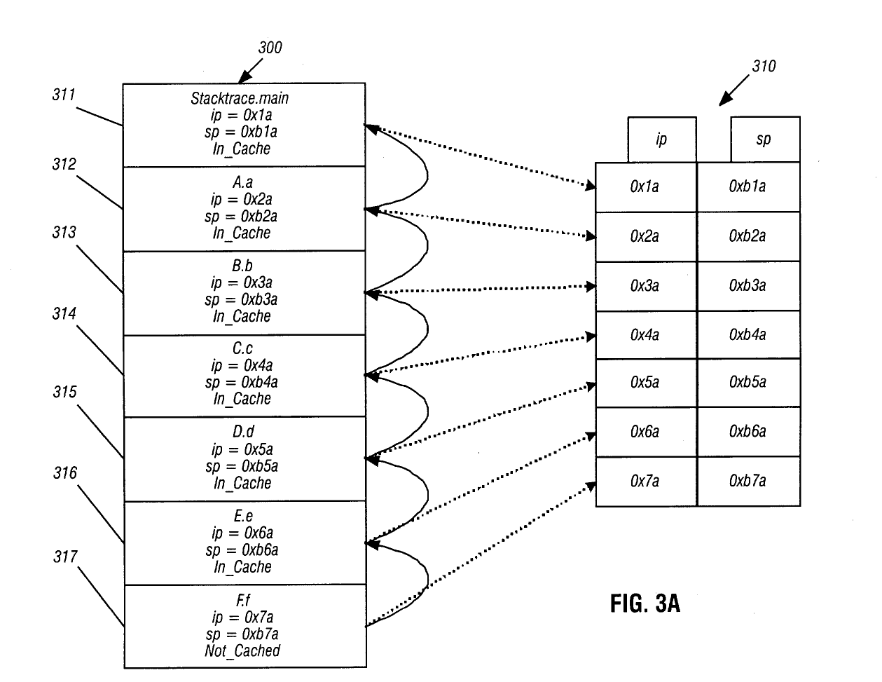

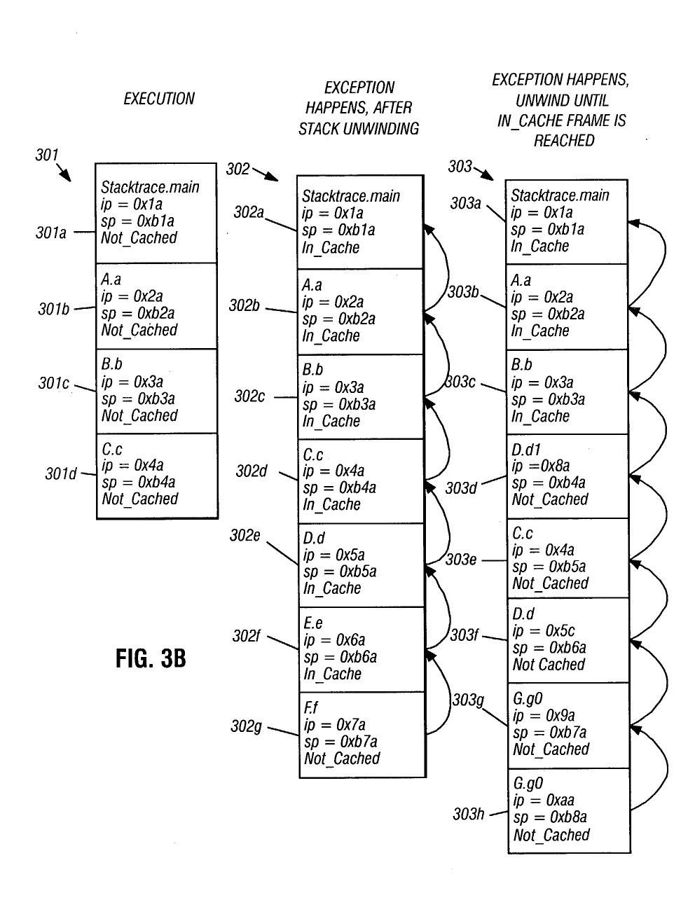

FIG. 3A is a representation of a runtime call stack 300 and a stack trace cache 310 after one full unwinding. The runtime call stack includes frames 311 to 317, each frame specifying an instruction pointer (ip) and stack pointer (sp). The specific ip and sp for each frame are examples that are intended for the sake of clarity. Stack trace cache 310 identifies the ip and sp for the stack frames unwound from the runtime call stack relating to an exception.

FIG. 3B is a representation of a snapshot of stack frames for a software program during execution, after a first exception, and a second or subsequent exception. Each stack frame may include a plurality of saved registers. Stack 301 includes stack frame 301a for the main program, stack frame 301b represents a program A.a called by the main program, stack frame 301c represents a program B.b called by program A.a, and stack frame 301d represents program C.c called by program B.b. In one embodiment, the compiler may tag each stack frame during execution of a software program as “not_cached” before an exception occurs.

In FIG. 3B, stack 302 represents a snapshot of stack frames 302a, 302b, 302c, 302d, 302e, 302f, 302g, after an exception happens. During unwinding, each stack trace frame that is tagged as “not_cached” is set to “In_cache” by setting the “in_cache” slot to true. Unwinding then may proceed to the next frame, until it reaches Stacktrace.main. At the end of the full unwinding, all frames are tagged with “in_cache” and have stack trace information, i.e., pairs of ip and sp, stored in the stack trace cache.

In FIG. 3B, stack 303 represents a snapshot of stack frames 303a-303h when a second exception happens. The stack unwinding can be sped up by using stack trace information for a first or earlier exception stored in the stack trace cache. The stack unwinding process begins from stack frame G.g0. Because the frame is not cached, the slot value may be reset to “in_cache” and continue unwinding to the next frame. When B.b frame is reached, which was previously tagged with “in_cache”, the rest of the stack trace information may be retrieved from the stack trace cache without further unwinding.

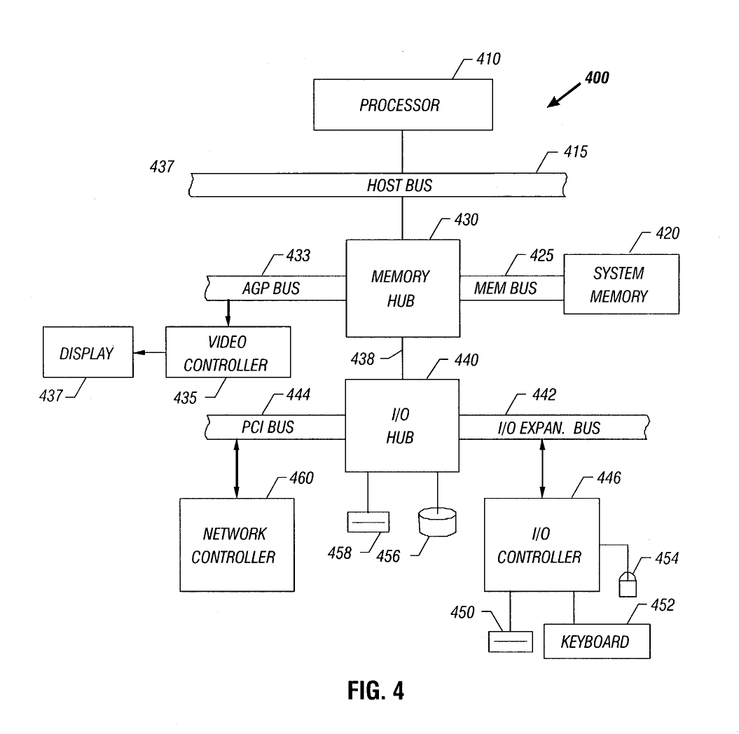

Example embodiments may be implemented in software for execution by a suitable data processing system configured with a suitable combination of hardware devices. FIG. 4 is a block diagram of a representative data processing system, namely computer system 400 with which embodiments of the invention may be used.

Now referring to FIG. 4, in one embodiment, computer system 400 includes processor 410, which may include a general-purpose or special-purpose processor such as a microprocessor, microcontroller, ASIC, a programmable gate array (PGA), and the like. As used herein, the term “computer system” may refer to any type of processor-based system, such as a desktop computer, a server computer, a laptop computer, an appliance or set-top box, or the like.

Processor 410 may be coupled over host bus 415 to memory hub 420 in one embodiment, which may be coupled to system memory 430 via memory bus 425. Memory hub 420 may also be coupled over Advanced Graphics Port (AGP) bus 433 to video controller 435, which may be coupled to display 437. AGP bus 433 may conform to the Accelerated Graphics Port Interface Specification, Revision 2.0, published May 4, 1998, by Intel Corporation, Santa Clara, Calif.

Memory hub 420 may also be coupled (via hub link 438) to input/output (I/O) hub 440 that is coupled to input/output (I/O) expansion bus 442 and Peripheral Component Interconnect (PCI) bus 444, as defined by the PCI Local Bus Specification, Production Version, Revision 2.1, dated in June 1995. I/O expansion bus 442 may be coupled to I/O controller 446 that controls access to one or more I/O devices. As shown in FIG. 4, these devices may include in one embodiment storage devices, such as keyboard 452 and mouse 454. I/O hub 440 may also be coupled to, for example, hard disk drive 456 and compact disc (CD) drive 458, as shown in FIG. 4. It is to be understood that other storage media may also be included in the system.

In an alternative embodiment, I/O controller 446 may be integrated into I/O hub 440, as may other control functions. PCI bus 444 may also be coupled to various components including, for example, network controller 460 that is coupled to a network port (not shown).

Additional devices may be coupled to I/O expansion bus 442 and PCI bus 444, such as an input/output control circuit coupled to a parallel port, serial port, a non-volatile memory, and the like.

Although the description makes reference to specific components of system 400, it is contemplated that numerous modifications and variations of the described and illustrated embodiments may be possible. For example, instead of memory and I/O hubs, a host bridge controller and system bridge controller may provide equivalent functions. In addition, any of a number of bus protocols may be implemented.

While the present invention has been described with respect to a limited number of embodiments, those skilled in the art will appreciate numerous modifications and variations therefrom. It is intended that the appended claims cover all such modifications and variations as fall within the true spirit and scope of the present invention.

What is claimed is:

1. A method comprising:
caching stack trace information relating to a stack frame for a first exception in a software program;
detecting if the stack frame has changed from the first exception to a subsequent exception; and
if the stack frame has not changed, copying the cached stack trace information to a stack trace for the subsequent exception.

2. The method of claim 1 further comprising tagging a stack frame to indicate the stack trace information relating to the stack frame is cached.

3. The method of claim 1 further comprising initializing a stack frame with a default value.

4. The method of claim 1 wherein caching stack trace information comprises caching an instruction pointer and a stack pointer.

5. The method of claim 4 wherein detecting if the stack frame has changed comprises detecting if the stack pointer has changed after the first exception.

6. The method of claim 1 wherein copying the cached stack trace information comprises copying stack trace information relating to a plurality of stack frames.

7. The method of claim 1 wherein copying the cached stack trace information comprises copying the source location of an exception handler.

8. A system comprising:
a processor to unwind stack frames in a runtime call stack to obtain stack trace information for an exception to a software program; and
cache memory to store the stack trace information including a source location of an exception handler.

9. The system of claim 8 further comprising an indicator to indicate that stack trace information is stored in the cache memory.

10. The system of claim 9 wherein the indicator is a slot in a stack frame.

11. The system of claim 10 wherein the slot has a true value if stack trace information for the stack frame is stored in the cache memory.

12. The system of claim 8 wherein the processor includes a compiler.

13. The system of claim 8 wherein the stack trace information includes an instruction pointer and a stack pointer.

14. An article comprising a machine-readable storage medium containing instructions that if executed enables a system to:
initialize an indicator showing that stack trace information for a stack frame is not stored in a cache memory; and
update the indicator if stack trace information for the stack frame is stored in the cache memory.

15. The article of claim 14, further comprising instructions that if executed enables a system to store the stack trace information for the frame in the cache memory.

16. The article of claim 14, further comprising instructions that if executed enables a system to copy stack trace information stored in the cache memory.

17. The article of claim 14, further comprising instructions that if executed enables a system to copy stack trace information stored in the cache memory for a plurality of stack frames.

18. The article of claim 14 wherein the stack trace information includes an instruction pointer and a stack pointer for the stack frame.

19. The article of claim 18 wherein the instruction pointer identifies the source location of an exception handler.

20. The article of claim 18 wherein the stack pointer identifies if the stack frame was popped since the last exception throwing.

21. A method comprising:
initializing an indicator showing that stack trace information for a stack frame is not stored in a cache memory; and
updating the indicator if stack trace information for the stack frame is stored in the cache memory.

22. The method of claim 21, further comprising storing the stack trace information for the frame in the cache memory.

23. The method of claim 21, further comprising copying stack trace information stored in the cache memory.

24. The method of claim 21, further comprising copying stack trace information stored in the cache memory for a plurality of stack frames.

25. The method of claim 21, wherein the stack trace information includes an instruction pointer and a stack pointer for the stack frame.

26. The method of claim 25, wherein the instruction pointer identifies the source location of an exception handler.

27. The method of claim 25, wherein the stack pointer identifies if the stack frame was popped since the last exception throwing.
